(19) United States
(12) Patent Application Publication
(10) Pub. No.: US 2020/0242711 A1
(43) Pub. Date: Jul. 30, 2020

(54) METHOD, COMPUTER PROGRAM PRODUCT AND APPARATUS FOR TRANSFERRING OWNERSHIP OF DIGITAL ASSETS

(71) Applicant: Auth9, Inc., Foster City, CA (US)

(72) Inventors: Ye CAO, Foster City, CA (US); Hongjun Li, Newark, CA (US); Kai Xu, Foster City, CA (US); Ning Xu, Foster City, CA (US)

(21) Appl. No.: 16/773,799

(22) Filed: Jan. 27, 2020

Related U.S. Application Data
(60) Provisional application No. 62/797,282, filed on Jan. 27, 2019.
(60) Provisional application No. 62/823,371, filed on Mar. 25, 2019.
(60) Provisional application No. 62/900,890, filed on Sep. 16, 2019.
(60) Provisional application No. 62/900,877, filed on Sep. 16, 2019.

(51) Int. Cl. G06Q 50/18; H04L 9/14

(52) U.S. Cl. CPC G06Q 50/18; H04L 2209/56; G06Q 2220/18; H04L 9/14

(57) ABSTRACT

A method, apparatus and computer program product are provided for transferring ownership of a digital asset including receiving, from a first computing device, a digital asset identifier, receiving a request to transfer ownership of the digital asset to be associated with a second computing device, deriving a first owner key from the digital asset identifier, deriving a digital asset key from the first owner key, generating, in response to the request, a second owner key, and verifying that the second computing device has ownership of the digital asset by verifying the digital asset key derived from the second owner key is related to at least one key of a digital asset key pair.

### CROSS-REFERENCE TO RELATED APPLICATIONS

This patent application claims priority from U.S. Provisional Appl. Ser. No. 62/797,282, filed Jan. 27, 2019, U.S. Provisional Appl. Ser. No. 62/823,371, filed Mar. 25, 2019, U.S. Provisional Appl. No. Ser. No. 62/900,890, filed Sep. 16, 2019, and U.S. Provisional Appl. No. Ser. No. 62/900,877, filed Sep. 16, 2019, all of which are incorporated herein by reference in its entirety.

### FIELD OF THE INVENTION

Embodiments of the present invention generally relate to digital assets or digital representations of physical assets, and the process of establishing ownership, affirming ownership, and transferring ownership of such digital assets.

### BACKGROUND OF THE INVENTION

Transferring ownership of physical objects is straightforward. Only two sides are necessary to complete the process: the current owner and the new owner. However, when it comes to digital assets, which could be easily copied or manipulated, transferring ownership becomes a problem if one side does not trust the other side. A solution is using a third-party entity, which can supervise the transferring process and determine the rightful owner and authenticity of the digital asset. But this only works when the third-party entity is trustworthy, because the third-party entity may maliciously change ownership on its own.

Through applied effort and ingenuity, these and other problems with current encryption methodologies have been addressed by certain embodiments discussed herein.

### BRIEF SUMMARY OF THE INVENTION

In general, embodiments of the present invention provided herein include systems, methods, apparatuses, and computer program products for transferring ownership of a digital asset. Certain embodiments utilize an owner key (e.g., symmetric encryption key) for encrypting at least one key of a digital asset key pair (e.g., digital asset private key). The owner key is used to decrypt the encrypted at least one key of the digital asset key pair to produce the at least one key.

In accordance with one aspect, an apparatus for transferring ownership of a digital asset comprising at least one processor and at least one non-transitory memory storing instructions that, when executed by the processor, configure the apparatus to receive, from a first computing device, a digital asset identifier, receive a request to transfer ownership of the digital asset to be associated with a second computing device, derive a first owner key from the digital asset identifier, derive a digital asset key from the first owner key, generate, in response to the request, a second owner key, and verify that the second computing device has ownership of the digital asset by verifying the digital asset key derived from the second owner key is related to at least one key of a digital asset key pair. The at least one non-transitory memory stores computer program code instructions that, when executed by the at least one processor, further configure the apparatus to remove the first owner key and the digital asset key from a registry.

In some embodiments, the digital asset identifier comprises a password associated with a user, a passcode associated with the user, an encryption key, or an identifier unique to the first computing device and/or data identifying the digital asset. The at least one non-transitory memory stores computer program code instructions that, when executed by the at least one processor, further configure the apparatus to encrypt the digital asset key with the second owner key of the second computing device to produce an encrypted digital asset key.

In another example embodiment, the apparatus is further configured to receive, from the first computing device, owner identity data and prior to transferring ownership of the digital asset to be associated with the second computing device, verify a user of the first computing device using the owner identity data. In some embodiments, the owner identity data comprises at least one of: at least one key of an encryption key pair, a telephone number, an email address, a passport, a driver's license, or biometric data.

In yet another example embodiment, the at least one non-transitory memory stores computer program code instructions that, when executed by the at least one processor, further configure the apparatus to receive a request to issue a digital asset, associate at least one owner key of an owner key pair and at least one facilitator key of a facilitator key pair to the digital asset, wherein the at least one owner key and a corresponding owner key form the owner key pair, the corresponding owner key is associated with an owner device; and wherein the at least one facilitator key and a corresponding facilitator key form the facilitator key pair, the corresponding facilitator key associated with a facilitator device, store a derived secret data corresponding to a secret data to be utilized for verifying the owner device, and transfer ownership of the digital asset based at least in part on the corresponding owner key, the corresponding facilitator key and the secret data.

In another example embodiment, the apparatus is further configured to receive a request to verify the owner device owns the digital asset, verify the owner device owns the digital asset using the derived secret data, and upon verification that the owner device owns the digital asset, apply a digital signature using the corresponding facilitator key from the facilitator key pair. The at least one non-transitory memory stores computer program code instructions that, when executed by the at least one processor, further configure the apparatus to verify that ownership of the digital asset is associated with the owner device based at least in part on respective digital signatures of both the facilitator device and the owner device.

In accordance with another aspect, the apparatus may be configured to receive a request to transfer ownership of the digital asset to be associated with a second owner device, upon the verification that the owner device owns the digital asset, store a second derived secret data corresponding to a second secret data associated with the second owner device to be utilized for verifying the second secret data is associated with the second owner device.

Computer program products and computer implemented methods are also configured to implement embodiments of the present disclosure. In accordance with one aspect, a computer implemented method comprises receiving, from a first computing device, a digital asset identifier, receiving a request to transfer ownership of the digital asset to be associated with a second computing device, deriving a first owner key from the digital asset identifier, deriving a digital asset key from the first owner key, generating, in response to the request, a second owner key, and verifying that the second computing device has ownership of the digital asset by verifying the digital asset key derived from the second owner key is related to at least one key of a digital asset key pair. The computer implemented method further comprises removing the first owner key and the digital asset key from a registry.

In some embodiments, the computer implemented method further comprises encrypting the digital asset key with the second owner key of the second computing device to produce an encrypted digital asset key. In another example embodiment, the method further comprises receiving, from the first computing device, owner identity data and prior to transferring ownership of the digital asset to be associated with the second computing device, verifying a user of the first computing device using the owner identity data.

In yet another example embodiment, the computer implemented method further comprises receiving a request to issue a digital asset, associating at least one owner key of an owner key pair and at least one facilitator key of a facilitator key pair to the digital asset, wherein the at least one owner key and a corresponding owner key form the owner key pair, the corresponding owner key is associated with an owner device; and wherein the at least one facilitator key and a corresponding facilitator key form the facilitator key pair, the corresponding facilitator key associated with a facilitator device, storing a derived secret data corresponding to a secret data to be utilized for verifying the owner device, and transferring ownership of the digital asset based at least in part on the corresponding owner key, the corresponding facilitator key and the secret data.

In another example embodiment, the computer implemented method further comprises receiving a request to verify the owner device owns the digital asset, verifying the owner device owns the digital asset using the derived secret data, and upon verification that the owner device owns the digital asset, applying a digital signature using the corresponding facilitator key from the facilitator key pair. The computer implemented method further comprises verifying that ownership of the digital asset is associated with the owner device based at least in part on respective digital signatures of both the facilitator device and the owner device.

In accordance with another aspect, the computer implemented method further comprises receiving a request to transfer ownership of the digital asset to be associated with a second owner device, upon the verification that the owner device owns the digital asset, determining a second secret data associated with the second owner device, and storing a second derived secret data corresponding to the second secret data to be utilized for verifying the second secret data is associated with the second owner device.

In accordance with another aspect, a computer program product is provided. The computer program product may comprise at least one computer-readable storage medium having computer-readable program code portions stored therein, the computer-readable program code portions comprising executable portions configured to receive, from a first computing device, a digital asset identifier, receive a request to transfer ownership of the digital asset to be associated with a second computing device, derive a first owner key from the digital asset identifier, derive a digital asset key from the first owner key, generate, in response to the request, a second owner key, and verify that the second computing device has ownership of the digital asset by verifying the digital asset key derived from the second owner key is related to at least one key of a digital asset key pair. The computer program instructions further cause the processor to remove the first owner key and the digital asset key from a registry.

The computer program instructions further cause the processor to encrypt the digital asset key with the second owner key of the second computing device to produce an encrypted digital asset key. In another example embodiment, the computer program product is further configured to receive, from the first computing device, owner identity data and prior to transferring ownership of the digital asset to be associated with the second computing device, verify a user of the first computing device using the owner identity data.

In yet another example embodiment, the computer program instructions further cause the processor to receive a request to issue a digital asset, associate at least one owner key of an owner key pair and at least one facilitator key of a facilitator key pair to the digital asset, wherein the at least one owner key and a corresponding owner key form the owner key pair, the corresponding owner key is associated with an owner device; and wherein the at least one facilitator key and a corresponding facilitator key form the facilitator key pair, the corresponding facilitator key associated with a facilitator device, store a derived secret data corresponding to a secret data to be utilized for verifying the owner device, and transfer ownership of the digital asset based at least in part on the corresponding owner key, the corresponding facilitator key and the secret data.

In another example embodiment, the computer program instructions further cause the processor to receive a request to verify the owner device owns the digital asset, verify the owner device owns the digital asset using the derived secret data, and upon verification that the owner device owns the digital asset, apply a digital signature using the corresponding facilitator key from the facilitator key pair. The computer program instructions further cause the processor to verify that ownership of the digital asset is associated with the owner device based at least in part on respective digital signatures of both the facilitator device and the owner device.

In accordance with another aspect, the computer program instructions further cause the processor to receive a request to transfer ownership of the digital asset to be associated with a second owner device, upon the verification that the owner device owns the digital asset, store a second derived secret data corresponding to a second secret data associated with the second owner device to be utilized for verifying the second secret data is associated with the second owner device.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a basic block diagram illustrating a system that may benefit from exemplary embodiments of the present invention;

FIG. 2 illustrates a block diagram that may be specially configured in accordance with an example embodiment of the present disclosure;

FIG. 3 illustrates a block diagram that may be specially configured in accordance with an example embodiment of the present disclosure;

FIG. 4A is a basic block diagram illustrating elements of an asset issuer, registry, and owner in accordance with an example embodiment of the present disclosure;

FIG. 4B is a basic block diagram illustrating an example encryption and decryption process that may benefit from exemplary embodiments of the present invention;

FIG. 4C is a basic block diagram illustrating a data owner, data store, and data user including data owner identification in accordance with an example embodiment of the present disclosure;

FIG. 5 is a basic block diagram illustrating multiple ownership of a digital asset that may benefit from exemplary embodiments of the present invention;

FIG. 6A is a basic block diagram of issuing and registering a digital asset in accordance with an example embodiment of the present disclosure;

FIG. 6B is a basic block diagram of transferring ownership of the digital asset in accordance with an example embodiment of the present disclosure;

FIG. 6C is a basic block diagram of transferring ownership of the digital asset with more than one facilitator in accordance with an example embodiment of the present disclosure;

FIG. 6D is a basic block diagram of transferring ownership of the digital asset with one facilitator and one issuer in accordance with an example embodiment of the present disclosure;

FIG. 7 is a basic block diagram of linking a digital asset to a certified public key in accordance with an example embodiment of the present disclosure;

FIG. 8 illustrates an exemplary flowchart depicting various operations performed in in accordance with an example embodiment of the present disclosure; and

FIG. 9 is a basic block diagram of an exemplary anti-fraud credit card transaction use case in accordance with an example embodiment of the present disclosure.

### DETAILED DESCRIPTION OF THE INVENTION

Embodiments of the present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

### I. Overview

To address problems associated with maintaining appropriate levels of trust during transfers of digital assets, a system is provided for transferring ownership of digital assets. The system relies on registration of digital assets to facilitate transfers with high levels of trust. First, to register a new digital asset to a registry of the system, the system creates a pair of encryption keys (digital asset private key/digital asset public key). The terms “key pair,” “cryptographic key pair,” and “public key cryptographic key pair” refer to asymmetric cryptography which is a form of cryptography comprising a pair of cryptographic keys—a public key and a private key. In some embodiments, the private key is kept secret, while the public key may be widely distributed. The keys are related mathematically. The digital asset public key is given to the issuer (bank) to include in the digital asset (digital cash). The issuer then digitally signs the digital asset public key and the digital asset data to get a digital signature. In this case, the digital asset includes the digital asset public key, digital asset data, and the issuer's digital signature. The system then creates a new symmetric ownership key, and encrypts the digital asset private key to get an encrypted digital asset private key. The system then transmits the symmetric ownership key to an owner. The system then destroys the digital asset private key and the symmetric ownership key and stores the encrypted digital asset private key. In this case, the owner is the only one who can decrypt the encrypted digital asset private key to get back the digital asset private key. Neither the issuer or the system has access to the digital asset private key without the owner providing the symmetric ownership key. The system is further configured to select an owner secret (such as a random number, an alphanumeric sequence, and/or the like) which should be known to the owner. The owner may utilize such an owner secret by providing the owner secret to the system (e.g., as user input) to prove to the system that he/she knows the secret. The system links ownership of the digital asset to the secret. In certain embodiments, at least the symmetric ownership key and the encrypted digital asset private key are required to recover the owner secret.

### II. Computer Program Products, Methods, and Computing Entities

Embodiments of the present invention may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of a data structure, apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, field programmable gate array, and/or other computing device.

As defined herein, a “computer-readable storage medium,” which refers to a physical storage medium (e.g., volatile or non-volatile memory device), may be differentiated from a “computer-readable transmission medium,” which refers to an electromagnetic signal.

### III. Exemplary System Architecture

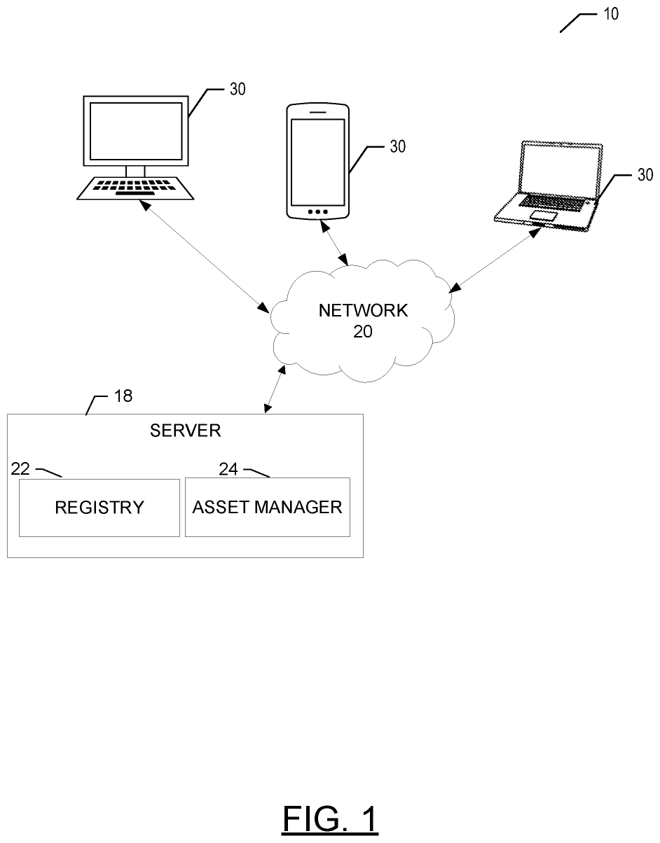

FIG. 1 is a basic block diagram illustrating a system 10 that may benefit from exemplary embodiments of the present invention. As shown and described herein, the system 10 could be employed in the context of a network 20 over which numerous electronic devices may communicate via wired, wireless or a combination of wired and wireless communication mechanisms. In an exemplary embodiment, the electronic devices may be embodied as personal computers (PCs) or other terminals that may enable individuals to run applications and/or communicate with each other in accordance with embodiments of the present invention. The network 20 may be any of a number of different communication backbones or frameworks including, for example, the Internet, a local area network (LAN), a personal area network (PAN), a campus area network (CAN), a metropolitan area network (MAN), or the like. In one exemplary embodiment, the server 18 could be part of a LAN or other localized network (e.g., associated with a particular company) and the server 18 may be in communication with the network 20 either directly or via a gateway device of the LAN.

a. Exemplary Server

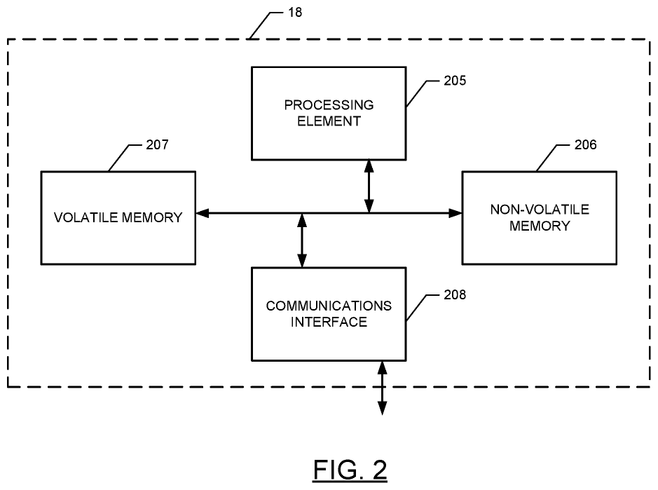

The server 18 may be a server or other computing platform including memory and processing capability (e.g., the volatile memory 207 and the processing element 205 of FIG. 2) and in communication with the network 20 in order to facilitate operation in accordance with embodiments of the present invention. In some embodiments, the server 18 may host a verification app providing access to the functionalities, devices and/or elements described in connection with the server 18 below.

FIG. 2 provides a schematic of a server 18 according to one embodiment of the present invention. In general, the terms computing entity, entity, device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the server 18 may also include one or more network and/or communications interfaces 208 for communicating with various computing entities, such as by communicating data, content, information, and/or similar terms used herein interchangeably that can be transmitted, received, operated on, processed, displayed, stored, and/or the like. For instance, the server 18 may communicate with other analytic computing entities, one or more user computing entities 30, and/or the like.

As shown in FIG. 2, in one embodiment, the server 18 may include or be in communication with one or more processing elements 205 (also referred to as processors, processing circuitry, and/or similar terms used herein interchangeably) that communicate with other elements within the server 18 via a bus, for example, or network connection. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the server 18 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 206 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to refer to a structured or unstructured collection of information/data that is stored in a computer-readable storage medium.

Memory media 206 may also be embodied as a data storage device or devices, as a separate database server or servers (as shown in FIG.1), or as a combination of data storage devices and separate database servers. Further, in some embodiments, memory media 206 may be embodied as a distributed repository such that some of the stored information/data is stored centrally in a location within the system and other information/data is stored in one or more remote locations. Alternatively, in some embodiments, the distributed repository may be distributed over a plurality of remote storage locations only.

Memory media 206 may include information/data accessed and stored by the server 18 to facilitate the operations of the server 18. More specifically, memory media 206 may encompass one or more data stores configured to store information/data usable in certain embodiments.

In one embodiment, the server 18 may further include or be in communication with volatile media (also referred to as volatile storage, memory, memory storage, memory circuitry and/or similar terms used herein interchangeably). In one embodiment, the volatile storage or memory may also include one or more volatile storage or memory media 207 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management system entities, data, applications, programs, program modules, scripts, source code, object code, byte code, compiled code, interpreted code, machine code, executable instructions, and/or the like being executed by, for example, the processing element 308. Thus, the databases, database instances, database management system entities, data, applications, programs, program modules, scripts, source code, object code, byte code, compiled code, interpreted code, machine code, executable instructions, and/or the like may be used to control certain aspects of the operation of the server 18 with the assistance of the processing element 205 and operating system.

As indicated, in one embodiment, the server 18 may also include one or more network and/or communications interfaces 208 for communicating with various computing entities, such as by communicating data, content, information, and/or similar terms used herein interchangeably that can be transmitted, received, operated on, processed, displayed, stored, and/or the like. For instance, the server 18 may communicate with computing entities or communication interfaces of other servers, terminals (e.g., user computing entities 30), and/or the like.

As indicated, in one embodiment, the server 18 may also include one or more network and/or communications interfaces 208 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the server 18 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The server 18 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

As will be appreciated, one or more of the analytic computing entity's components may be located remotely from other server 18 components, such as in a distributed system. Furthermore, one or more of the components may be aggregated and additional components performing functions described herein may be included in the server 18. Thus, the server 18 can be adapted to accommodate a variety of needs and circumstances.

b. Exemplary User Computing Entity

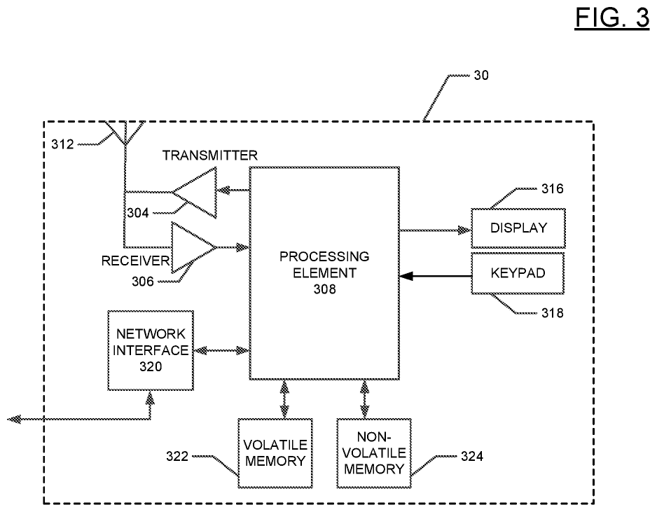

FIG. 3 provides an illustrative schematic representative of user computing entity 30 that can be used in conjunction with embodiments of the present invention. As will be recognized, the user computing entity may be operated by an agent and may include components and features similar to those described in conjunction with the server 18. Further, as shown in FIG. 3, the user computing entity may include additional components and features. For example, the user computing entity 30 can include an antenna 312, a transmitter 304 (e.g., radio), a receiver 306 (e.g., radio), a network interface 320, and a processing element 308 that provides signals to and receives signals from the transmitter 304 and receiver 306, respectively and/or the network interface 320. The signals provided to and received from the transmitter 304 and the receiver 306, respectively, may include signaling information/data in accordance with an air interface standard of applicable wireless systems to communicate with various entities, such as server 18, another user computing entity 30, and/or the like. In this regard, the user computing entity 30 may be capable of operating with one or more air interface standards, communication protocols, modulation types, and access types. More particularly, the user computing entity 30 may operate in accordance with any of a number of wired or wireless communication standards and protocols. In a particular embodiment, the user computing entity 30 may operate in accordance with multiple wireless communication standards and protocols, such as GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the user computing entity 30 can communicate with various other entities using concepts such as Unstructured Supplementary Service data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 30 can also download changes, add-ons, and updates, for instance, to its firmware, software (e.g., including executable instructions, applications, program modules), and operating system.

According to one embodiment, the user computing entity 30 may include location determining aspects, devices, modules, functionalities, and/or similar words used herein interchangeably. For example, the user computing entity 30 may include outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including LEO satellite systems, DOD satellite systems, the European Union Galileo positioning systems, the Chinese Compass navigation systems, Indian Regional Navigational satellite systems, and/or the like. Alternatively, the location information/data/data may be determined by triangulating the position in connection with a variety of other systems, including cellular towers, Wi-Fi access points, and/or the like. Similarly, the user computing entity 30 may include indoor positioning aspects, such as a location module adapted to acquire, for example, latitude, longitude, altitude, geocode, course, direction, heading, speed, time, date, and/or various other information/data. Some of the indoor aspects may use various position or location technologies including RFID tags, indoor beacons or transmitters, Wi-Fi access points, cellular towers, nearby computing devices (e.g., smartphones, laptops) and/or the like. For instance, such technologies may include iBeacons, Gimbal proximity beacons, BLE transmitters, Near Field Communication (NFC) transmitters, and/or the like. These indoor positioning aspects can be used in a variety of settings to determine the location of someone or something to within inches or centimeters.

The user computing entity 30 may also comprise a user interface comprising one or more user input/output interfaces (e.g., a display 316 and/or speaker/speaker driver coupled to a processing element 308 and a touch screen, keyboard, mouse, and/or microphone coupled to a processing element 308). For example, the user output interface may be configured to provide an application, browser, user interface, dashboard, webpage, and/or similar words used herein interchangeably executing on and/or accessible via the user computing entity 30 to cause display or audible presentation of information/data and for user interaction therewith via one or more user input interfaces. The user output interface may be updated dynamically from communication with the server 18. The user input interface can comprise any of a number of devices allowing the user computing entity 30 to receive data, such as a keypad 318 (hard or soft), a touch display, voice/speech or motion interfaces, scanners, readers, or other input device. In embodiments including a keypad 318, the keypad 318 can include (or cause display of) the conventional numeric (0-9) and related keys (#, *), and other keys used for operating the user computing entity 30 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the user computing entity 30 can collect information/data, user interaction/input, and/or the like.

The user computing entity 30 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the user computing entity 30.

c. Exemplary Server Modules

In various embodiments, the server 18 comprises, amongst other elements, a registry 22 and an asset manager 24. The registry 22 comprises one or more data stores, encryption keys, encryption data, asset data, and data owner information. Encryption keys may include digital information (e.g., data structure; one or more items of data; and the like) that determines the functional output of a cryptographic algorithm. An encryption key specifies the transformation of private data plaintext (or other plaintext) into private data ciphertext (or other ciphertext), and/or vice versa. In an example embodiment, the encryption key is a cryptography random number (e.g., 256-bit key).

In an example embodiment, asset data is stored in the one or more data stores, and the user key is held by an authorized party (e.g., authorized data owners and/or data users), which in this case is an owner of user computing entity 30. Hence, only the owner, as holder of the user key, has access to the asset data and permission to transfer ownership of the asset data. Data encryption can be performed at the user computing entity 30, or preferably at the server 18.

The asset manager 24 is configured to manage asset data, verify asset ownership, facilitate asset ownership transfer, and/or manage owners' encryption keys. In another example embodiment, the asset manager 24 may store and manage asset data and the ownership of the asset data as well as enforce permission policies. Additionally or alternatively, the asset manager 24 may store some data about the asset but not the asset itself. In another example embodiment, the data owner stores the asset, but access is permitted through the asset manager. In another example embodiment, the asset and/or asset data may be stored by the asset manager or the user computing entity 30 unencrypted. For example, the asset manager 24 is configured to authenticate a data owner prior to cryptographic processing of data or transferring of data. In an example embodiment, the server 18 is configured to implement one or more authentication methods such as, but not limited to, one time passwords or passphrases or a password recovery question and answer. The server 18 may provide an interface through which a data owner using a user computing entity 30 may identify the asset data to share and transfer ownership to another user.

In embodiments where a user computing entity 30 is a mobile device, such as a smart phone or tablet, the user computing entity 30 may execute an “app” to interact with the server 18. Such apps are typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

d. Exemplary Networks

In one embodiment, the networks 20 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 20 may have any suitable communication range associated therewith and may include, for example, global networks (e.g., the Internet), MANs, WANs, LANs, or PANs. In addition, the networks 20 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

### IV. Exemplary System Operation

Certain embodiments as discussed herein utilize public-key cryptography, symmetric encryption (e.g., Advanced Encryption Standard (AES), and cryptographic hashing (e.g., Secure Hash Algorithm (SHA-256) or Password-Based Key Derivation Function 2 (PBKDF2)). although other encryption methodologies may be utilized in certain embodiments. Public-key cryptography may be utilized for key generation and data encryption as well as generating digital signatures and/or for authentication. Public-key encryption and/or digital signature schemes may be used including, without limitation, Rivest-Shamir-Adelman (RSA), Elliptic Curve, Quantum Safe algorithms, and/or the like. Encryption strength may be selected based at least in part on the selected encryption scheme and/or security requirements utilized.

a. Registering, Assigning, Transferring, and Verifying Ownership of Digital Asset(s)

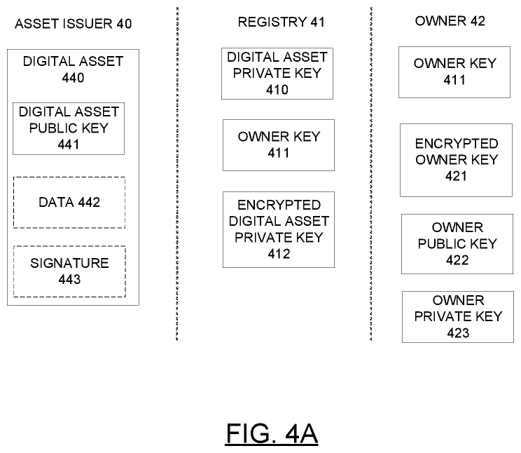

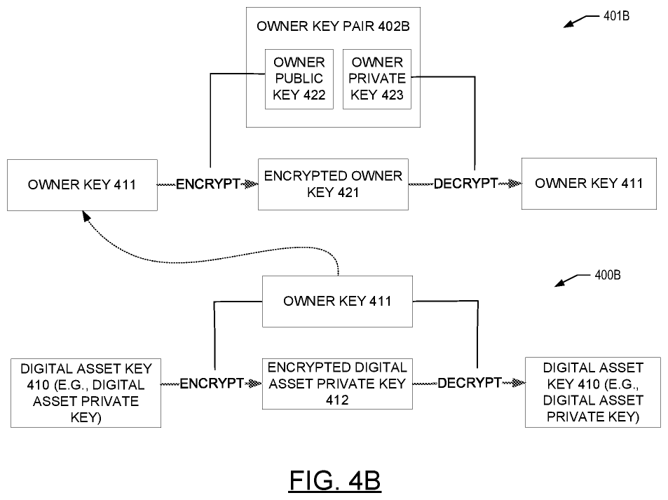

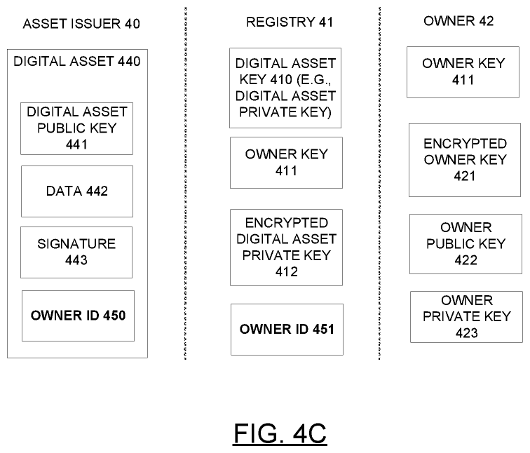

As shown in FIG. 4A, three parties are involved in the process of assigning, transferring, and verifying ownership of a digital asset. In some embodiments, the digital asset 440 is issued or created by an asset issuer 40 (e.g., digital cash issued by a banking institution). The ownership of the digital asset 440 is registered at a registry 41 (such as by registry 22 of server 18) and the ownership of the digital asset 440 is assigned or transferred to an owner 42 by the registry 41, working with the asset issuer 40 or the owner 42.

In some embodiments, the digital asset 440 may be embodied as anything in digital format. For example, the digital asset 440 may be pure digital data of any kind, for example an encryption key, a piece of song or music, etc. A digital asset may be linked to/associated with real world assets like currencies, financial assets, or physical assets, etc. As shown in FIG. 4A, the digital asset 440 comprises data 442 which includes the nature or details of the digital asset 440. The data asset 440 may optionally include data 442 such a picture of the asset, data that may identify the asset, and the like. The digital asset 440 may further include a digital signature 443 of the asset issuer 40 to prove the authenticity and/or the origin of the digital asset 440. The digital signature 442 of the asset issue 40 is optional.

i. Registering a Digital Asset

In some embodiments, to register a digital asset 440, the registry 41 (such as by registry 22 of server 18) first creates a pair of public keys: digital asset public key 441 and digital asset key 410 (e.g., digital asset private key), as depicted in FIG. 4A. The digital asset public key 441 is given to the asset issuer 40 to include in the digital asset 440. The asset issuer 40 may then digitally sign the digital asset public key 441 and the data 442 of the digital asset 440 to get the digital signature 443. In this case, the digital asset 440 which includes the digital asset public key 441, optionally the data 442, and optionally the asset issuer's digital signature 443.

In some embodiments, the registry 41 may then create a new symmetric encryption key (such as owner key 411 of FIG. 4A) and may further encrypt the digital asset key 410 to produce the encrypted digital asset private key 412 using the owner key 411. In some embodiments, the owner key 411 is transmitted/given to the owner 42. In an example embodiment, the registry 41 may then destroy or discard the digital asset key 410 and the owner key 411, and store the encrypted digital asset private key 412. After this example registration process, the owner 42 is the only one who can decrypt the encrypted digital asset private key 412 to get back the digital asset key 410. In this case, neither the asset issuer 40 nor the registry 41 has access to the digital asset key 410 without the owner 42 providing the owner key 411.

Alternatively or additionally, the owner key 411 may be passed or transmitted to an owner by encrypting the owner key 411 with an owner public key 422 of the owner to get an encrypted owner key 421. As such, only the owner 42 can only decrypt encrypted owner key 421 to get back the owner key 411, since the owner 42 is the only one who has access to owner private key 423 corresponding to owner public key 422. In some embodiments, the asset issuer 40 and the registry 41 can be the same party or entity.

FIG. 4B illustrates encryption schemes that can be used to improve security related to registering and verifying ownership of a digital asset. 400B and 401B of FIG. 4B shows example cryptographic concepts using an owner key 411 and an owner key pair 402B. 400B shows owner key 411 used to encrypt the digital asset key 410 to produce encrypted digital asset private key 412. The same owner key 411 is used to decrypt the encrypted digital asset private key 412 to get back digital asset key 410.

As shown by 401B, owner key pair 420B includes an owner public key 422 and an owner private key 423. The owner public key 422 is used to encrypt owner key 411 to produce encrypted owner key 421. In order to decrypt encrypted owner key 421, the owner private key 423 is needed to get back owner key 411.

In certain embodiments, the encryption at each of the encryption levels may utilize encryption keys such as symmetric keys or private/public key pairs. The encryption algorithm may comprise Advanced Encryption Standard (AES), Rivest-Shamir-Adleman (RSA), Elliptic Curves, and/or the like.

ii. Single Owner to Single Owner Digital Asset Transfer

Upon transferring ownership of the digital asset 440, ownership of the digital asset 440 may be proved by owner 42 by providing the owner key 411 and optionally the digital asset 440 to the registry 41 (such as owner key 411 of FIG. 4A). The registry 41 may then decrypt the encrypted digital asset private key 412 with the owner key 411 to get back the digital asset key 410. In this case, ownership is proven if the resulting digital asset key 410 and the digital asset public key 441 of the digital asset 440 are part of the same key pair. The digital asset key 410 and the owner key 411 are disposed by the asset manager 24 once such verification process is completed. The verification process to prove the keys are the same pair can be done by a party other than the registry 41. For example, if a party wants to verify the ownership of the digital asset 440, the party may provide a random number for the owner 42 to encrypt or sign with the corresponding digital asset key 410 of the digital asset 440. The party may then user the digital asset public key 441 of the digital asset 440 to decrypt the encrypted random number to get it back, and therefore prove that the owner 42 has access to the digital asset key 410 and is the current owner.

In some embodiments, ownership can only be transferred by the owner 42, working together with the registry 41. In this case, the owner 42 may transmit the owner key 411 and a new owner public key of a new owner (not pictured). The registry 41 uses the owner key 411 to decrypt the encrypted digital asset private key 412 to get back the digital asset key 410. The registry 41 then generates a new owner key, encrypts the digital asset key 410 with the new owner key to get a new encrypted digital asset private key, encrypts the new owner key with the new owner public key of the new owner to get a new encrypted owner key, sends the new encrypted owner key to the new owner (optionally the new encrypted owner key can be transmitted to the new owner by the previous owner, or the new encrypted owner key can be saved on the registry, etc.), and then destroys the digital asset key 410, the new owner key, and the previous encrypted digital asset private key, and stores only the new encrypted digital asset private key. At this point, only the new owner can prove the ownership of the digital asset. The previous owner does not have proof of ownership anymore since the previous encrypted digital asset private key is destroyed. Although the previous owner may still has his or her owner key, it is useless without the other half, that is the previous encrypted digital asset private key which is now destroyed.

iii. Multiple Owners

In some embodiments, a digital asset can be set up to have multiple owners. In such case, any one of the owners is permitted to transfer the digital asset to another owner. For example, the registry 41 (such as by registry 22 of server 18) generates one half key (such as owner key 411) for each owner, and saves the corresponding other half key (encrypted digital asset private key 412). Every one half key (owner key 411) of the owners alone can decrypt the corresponding other half key (encrypted digital asset private key 412) to produce/derive/get back the digital asset private key and hence to enable the registry 41 to transfer the digital asset. Once one owner transfers the ownership, all the other half keys (encrypted digital asset private key 412) of said digital asset are deleted from the registry 41. As a result, only the new owner(s) have access to the digital asset.

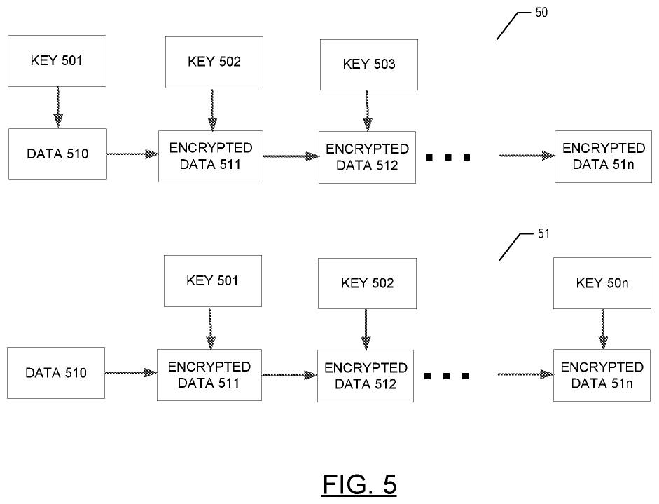

Alternatively or additionally, the registry 41 may only allow transferring the digital asset only if all the owners agree to the transfer. For example, as shown in FIG. 5, multiple key encryption can be performed. Data 510 is first encrypted with a symmetric key 501 generated by the registry 41 to get the encrypted data 511, then data 511 is encrypted again with a second symmetric key 502 to get the double encrypted data 512, and this process is repeated number N times to get the N times encrypted data 51n. The N keys 501, 502, 503, . . . 50n are given one to each owner and discarded by the registry 41. The registry 41 only saves the N times encrypted data 51n. To transfer the ownership the N keys 501, 502, 503, . . . 50n are sent to the registry 41. The registry 41 decrypts the encrypted data 51n in the reverse order of the encryption process above using the keys 50n, . . . , 503, 502, 501 to get back the original data 510, as shown in FIG. 5. Data 510 is equivalent to digital asset key 410 in FIG. 4A, keys 501, 502, . . . , 50n are equivalent to owner key 411, and encrypted data 51n is equivalent to encrypted digital asset private key 412 in FIG. 4A.

Another embodiment of multiple key encryption is to use the public keys of asymmetric key pairs for keys 501, 502, 503, . . . 50n in FIG. 5, instead of symmetric keys. In this case, there is no need to send the keys to the owners since they own the corresponding private keys.

In some embodiments, the registry 41 is configured to allow M out of N members to transfer ownership. For example, two out of three owners can be implemented by this arrangement. Assuming the three keys are key1, key2, and key3. The registry 41 saves three double encrypted data 512 as in FIG. 5. The first data 510 is the result encrypted with key1 and key2, the second data 511 is the result encrypted with key1 and key3, and the third data 512 is the result encrypted with key2 and key3. This way, any two of the three owners can transfer the ownership. In this case, the registry 41 links ownership of a digital asset to a secret (e.g., key). At least two other secrets are required to recover the first secret. At least one of the other secret is kept by a registry 41, and the other secrets are kept by the owners. The owners who can recover the first secret together with the other secrets of the registry have the ownership, and have the right to transfer the ownership.

iv. Owner Identity Data Added to the Digital Asset

In another embodiment, the owner key 411 can be created or derived from a piece of data that the owner 42 selects, for example a password or passphrase. Creating or deriving can be operations like hashing and/or adding “salt” to the owner data so that once the owner's secret data (e.g., owner key 411) is discarded by the registry 41 it will be hard or computationally impossible for the registry 41 to get it back. As a result, only the owner 42 can transfer the ownership since he is the only one who has the secret data. The owner key 411 should be created/derived in such a way that once the owner 42 provides his password or passphrase it can be restored by the registry 42. Note that an owner's password or passphrase can be saved as is by the registry 41 but it is not as secure.

In some embodiments, ownership of a digital asset may be verified using an owner ID (such as owner ID 450 of FIG. 4C). For example, a separate owner ID 450 or owner identity data may be added to the digital asset 440 as shown in FIG. 4C. Owner ID 450 can be anything that an owner can prove that he or she is the owner of or can get access to the data itself or a physical object linked to the data. For instance, owner ID 450 can be a public key of which an owner 42 has the corresponding private key. Owner ID 450 can also be a communication endpoint ID like a phone number, an email, an ID in software applications like WhatsApp ID, Google Authenticator, etc. Only the owner of these endpoints can get messages sent to or originated from these endpoints. Owner ID 450 can be some owner identity data like a passport, driver's license, etc. Owner ID 450 can also be some biometric data of the owner, for example a fingerprint of the owner, a picture of the owner, etc. In some embodiments, owner ID 450 may be a picture of a unique physical object, such as a photo of a skeleton of a leaf if the owner can prove he has access to the physical object. Owner ID 450 can be a part or portion of one or more IDs described above, such as the last N digits of a phone number. It should be understood that the owner ID 450 is not limited to this list. Moreover, it should be understood that more than one piece of owner ID 450 can be included in an asset 440. Optionally the owner ID 450 can be digitally signed by the asset issuer 40.

In some embodiments, the owner public key 422 of an owner 42 can be used as an owner ID 450 in FIG. 4C. When an owner 42 presents his or her digital asset 440, for example a credit card to pay for online shopping, the owner 42 can sign his shopping cart data with his owner private key 423 to prove that he or she is the owner of the digital asset (such as the credit card). Even if a thief obtains a copy of the owner's credit card, the thief cannot prove he is the owner without the owner private key 423.

In another embodiment, the owner ID 450 can be used to alert the owner when his digital asset 440 is used. For example, whenever an owner's credit card is used, a message can be sent to his phone (e.g., via a phone number utilized as the owner ID) or email (e.g., via the email utilized as the owner ID) to notify him of the spending. Owner ID 450 can also be used as a way to get the owner's approval for using or transferring the digital asset 440. For example, after an owner 42 submits their credit card for an online purchase, an authorization code or message may be sent to their phone number (e.g., utilized as the owner ID), which enables the owner to click a confirmation link (e.g., provided with the message) or provide his approval for the transaction. Multiple owner IDs can be linked to an asset for this purpose.

In another example embodiment, owner ID 450 of a new owner can also be added to the registry 41 and linked to the asset 440 when ownership is transferred, as shown in FIG. 4C. One way is to add the new owner's owner ID 450 as a separate record as shown in FIG. 4C. Another embodiment is to encrypt the owner ID with the owner key 411 that is used to encrypt the digital asset key 410 and save the resulting cipher (e.g., owner ID 451). This way even the registry 41 cannot change owner ID 451 without the owner providing the owner key 411. In this case, a new owner of the digital asset can confirm their ownership of the asset before the ownership transfer and that their owner ID is now linked to the current ownership of the asset after the transfer.

Linking owner IDs may also be used as a record. For example, when a new asset is transferred, the owner ID 450 is recorded/linked to a unique identifier of the asset. When the ownership is queried, the owner ID 450 can be returned together with other data of the asset. When the ownership of the asset is transferred, a new owner ID may be linked with the asset to which the new owner can check and verify.

b. Entities Involved in Issuing and Transferring Ownership of a Digital Asset

In some embodiments, a third-party entity (“middle man” or facilitator) may be used to supervise the transferring processes and determine the authorized owner. In certain example embodiments, at least one facilitator is utilized to transfer ownership from one owner to another owner, but the facilitator does not need to be trusted by the owners because each owner has a secret known only to themselves. In an example embodiment, each party: the facilitator, the current owner, and the previous owner each have a secret where their secret is known only to themselves and all three secrets are required to transfer ownership of a digital asset.

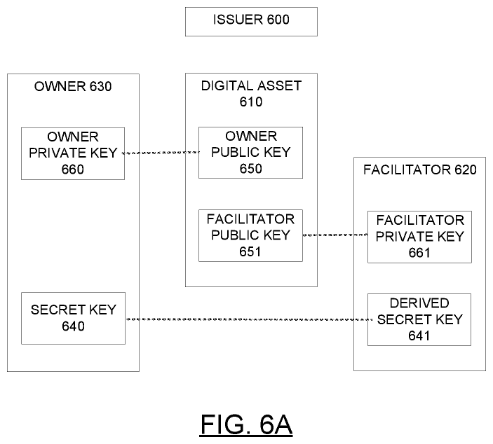

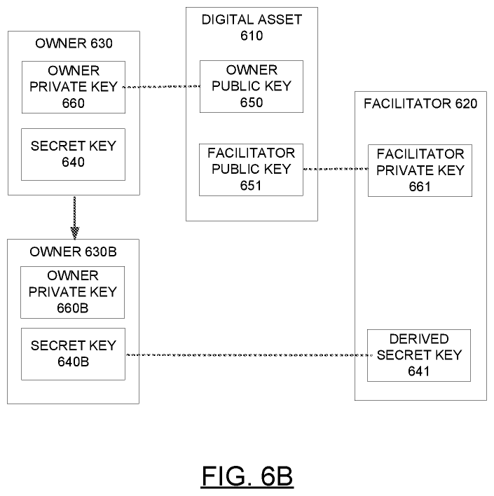

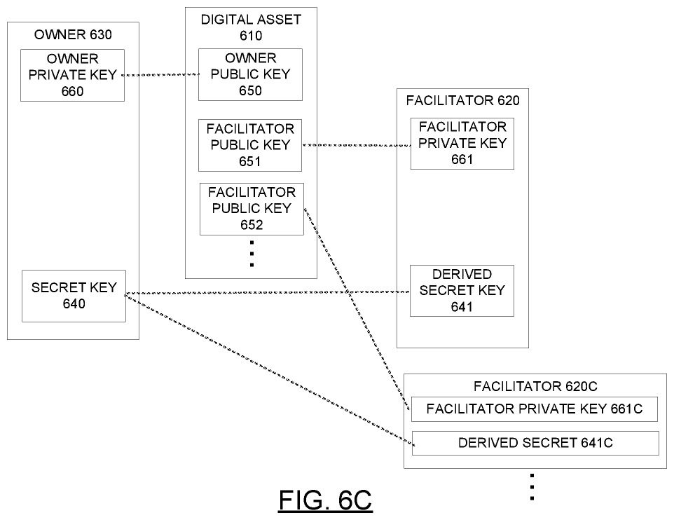

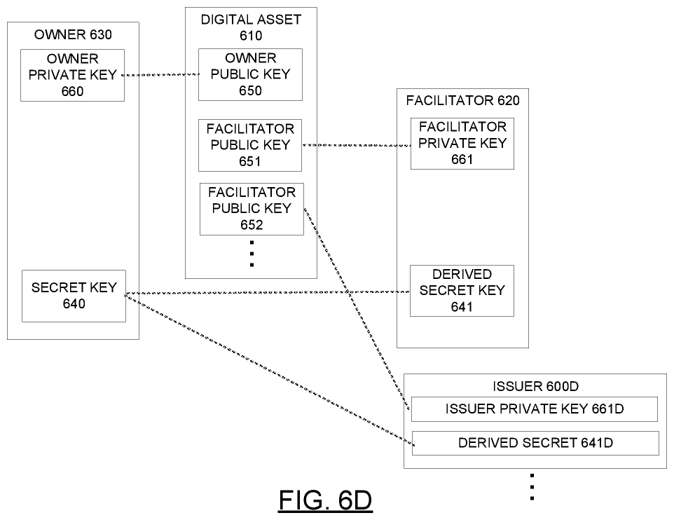

As shown in FIG. 6A, an issuer 600 issues a digital asset 610 to an owner 630, wherein two public key pairs (owner private key 660, owner public key 650) and (facilitator private key 661, facilitator public key 651) are generated. The owner private key 660 is known to the owner 630 and not to the facilitator 620, and the facilitator private key 661 is known to the facilitator 620 and not to the owner 630. The public keys (651) and (650) are linked to digital asset 610. The facilitator 620 has the facilitator private key 661 corresponding to the facilitator public key 651. The owner 630 has the owner private key 660 corresponding to the owner public key 650. Linking the assets to the owner 630 and facilitator 620 may be done, for example, with a digital signature of the issuer 600 (not shown) of the digital asset 610.

In some embodiments, a secret key 640 is selected, which should be known to the owner 630 and the owner 630 should be able to prove to the facilitator 620 that they know the secret key 640. As used herein, the terms “secret key 640,” “secret key,” “second secret key,” “secret data,” and “second secret data” and similar terms may be used interchangeably to refer to data or an encryption key known to an owner. The facilitator 620 knows a derived secret key 641 that is derived from secret key 640. With the derived secret key 641, the facilitator 620 may be able to verify that an owner 630 knows its corresponding secret key 640. Optionally, the derived secret key 641 may be signed or encrypted with the owner private key 660 of the owner 630 so that only the owner 630 can select the secret key 640. In an example embodiment, to select a secret 640 is to generate a random number or text. The corresponding derived secret key 641 is the same random number or text. In this case, to verify the owner 630 knows the secret key 640, the facilitator 620 will request the owner 630 to provide the secret 640. The facilitator will then compare the secret 640 with the derived secret 641 to make sure they match. Alternatively or additionally, the owner private key 660 is known only to the owner 630 and it can be used as the secret key 640. The derived secret key 641 is the corresponding public key. To verify the owner 630 knows the secret key 640 the facilitator 620 requests the owner 630 to provide a digital signature with the owner private key 640 and verify the signature with the derived secret key 641 the facilitator 620 knows as described in further detail below.

i. Ownership Verification

The process to verify or prove the ownership of the digital asset 610, a verifier (e.g., a party who wants to verify the ownership of an asset) can provide a random number (or text) to the owner 630. The owner 630 may sign the random number with the owner private key 660 to prove that it has owner private key 660. The facilitator may verify that the owner 630 knows the secret key 640 corresponding to the derived secret key 641. After verifying, the facilitator signs the random number with the facilitator private key 661. In this case, two digital signatures of the random number with both owner private key 660 and facilitator private key 661 serve as proof of ownership.

ii. Ownership Transfer Process

The process for transferring ownership of an asset as shown in FIG. 6B may include the facilitator 620 verifying that the current owner 630 is the real owner of the asset 610 and the current owner 630 transferring the owner private key 660 to a new owner 630B as shown in FIG. 6B. A new owner secret key 640B should be selected, which should be known to the new owner 630B only and unknown to the current owner 630. The derived secret key 641 of secret key 640B is made known to the facilitator 620.

Once the above process is complete, the previous owner 630 cannot prove his ownership over the asset anymore since they do not know the new secret key 640B. The facilitator 620 will not verify an owner if an owner cannot provide the current secret (e.g., secret key 640B). At all times, the three parties (the previous owner 630, the facilitator 620, and the current owner 630B) never know at least one of the thee secrets. The previous owner 630 does not know the current secret key 640B. The facilitator 620 does not know the owner private key 660 of the owner 630. The current owner does not know the facilitator private key 661 of the facilitator 620. All three secrets (e.g., private keys or secrets) are needed in order to verify ownership or transfer ownership.

In some embodiments, more than one facilitator is involved in an ownership transfer process, as shown in FIG. 6C. For each additional facilitator 620C one more facilitator public key 652 is added to asset 610 for the additional facilitator 620C. This is presented in FIG. 6C as new facilitator public key 652 associated with digital asset 610. The corresponding facilitator private key 661C is only known to the new facilitator 620C. Secret key 640 can be the same, or different for each facilitator, for example the same owner private key 660 of the owner 630. The derived secret for facilitators can be the same or different as well, for example, the owner public key 650 of the owner secret key 640. To prove or transfer ownership, one additional digital signature for each new facilitator is required. The new facilitator 620C may verify the owner secret key 640 in the same way as the first facilitator 620, and provide a signature with the new facilitator private key 661C to certify the ownership. In another embodiment, not all the facilitators need to certify an ownership. A subset of the number of facilitators may be utilized (e.g., the subset satisfying a threshold) or a percentage can be set, for example, more than 50% of the facilitators.

In some embodiments, as shown in FIG. 6D, there is only one facilitator 620 and the issuer 600D serves as the second facilitator. Both the facilitator 620 and the issuer 600D need to certify an asset 610. In some embodiments, the facilitator 620 is the issuer 600D who issued the asset 610. In this example embodiment, the facilitator 620 serves as the only facilitator.

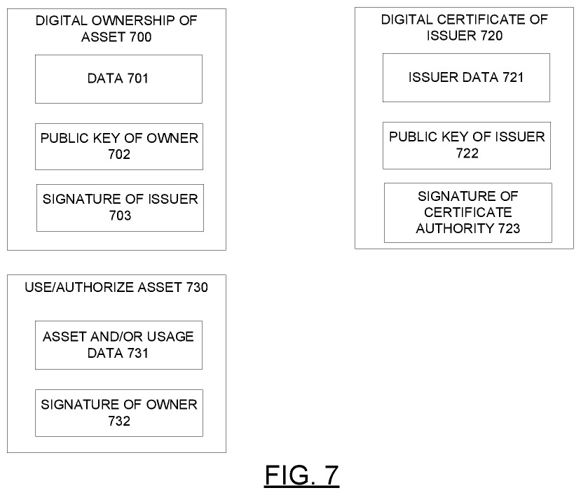

In another example embodiment and as shown in FIG. 7, a digital asset may be linked to a certified public key. For example, at least one certificate authority (not pictured) certifies an issuer (not pictured) to create a digital certificate of issuer 720. When an asset is issued the asset data 701 and a public key of owner 702 is signed by the issuer using the digital certificate of issuer 720 to get a digital signature of issuer 703. As such, digital ownership of asset 700 is linked to data 701 and to the public key of owner 702. The issuer can verify the identity of the owner and the ownership of the public key of owner 702 when issuing an asset which links the asset to the owner.

To use an asset, the owner signs the asset and/or usage data 731 using his/her private key of the public key 702 to get a digital signature 732 of the asset. The owner can then send the authorization 730 to an interested party for verification. To authenticate user/authorization 730, the signature 732 of the owner, the signature 703 of the issuer, the signature of the certificate authority 723 need to be verified. Further, the certificate authority needs to be verified as a valid and trustworthy authority.

c. Data Flow Examples

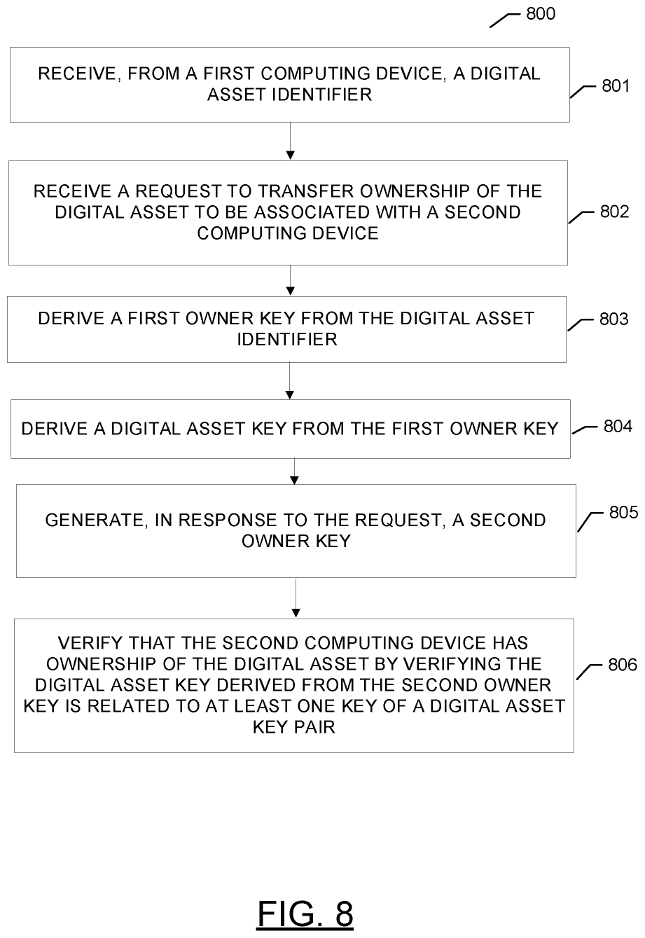

FIG. 8 illustrates an exemplary data flow for registering and transferring ownership of a digital asset, according to one embodiment of the present disclosure. In embodiments, routine 800 begins in block 801 with server 18 receiving, from a first computing device, a digital asset identifier corresponding with a digital asset and/or a digital representation of a physical asset. The digital asset or digital representation of a physical asset may include digital data such as pictures or identifying data associated with the digital asset. In some embodiments, the digital asset and asset data may be signed by the issuer of the asset. The digital asset identifier comprises a password or passcode associated with a user or an identifier unique to the computing device of the user such as a Media Access Control (MAC) address. The digital asset identifier may further include data identifying the digital asset.

In block 802, routine 800 continues with server 18 receiving a request to transfer ownership of the digital asset to be associated with a second computing device. The request may further include identifying information related to the second computing device.

In block 803, routine 800 continues with server 18 deriving a first owner key from the digital asset identifier. Once the server 18 obtains the first owner key, the server 18 derives a digital asset key (e.g., digital asset private key) from the first owner key as shown in block 804. In block 805, routine 800 continues with server 18 generating, in response to the request to transfer ownership of the digital asset to be associated with a second device, a second owner key. In some embodiments, the second owner key may be used to encrypt the digital asset key of a digital asset key pair to produce an encrypted digital asset key (e.g., encrypted digital asset private key).

In block 806, routine 800 continues with server 18 verifying that the second computing device has ownership of the digital asset by verifying the digital asset key derived from the second owner key is related to at least one key of a digital asset key pair (e.g., digital asset private key of the digital asset key pair). In other words, ownership is verified when the digital asset key and digital asset public key are from the same key pair.

In some embodiments, to register a new digital asset to the registry, such as registry 41 of FIG. 4A, the server 18 is further configured to create a digital asset key pair comprising a digital asset public key 441 and a digital asset private key 410 as shown in FIG. 4A. The server 18 then transmits the at least one key of the digital asset key pair (e.g., digital asset public key of the digital asset key pair) to a computing device of the asset issuer 40 to be utilized for signing the at least one key of the digital asset key pair and the digital asset data 442 using the digital asset key of the digital asset key pair (e.g., digital asset public key of the digital asset key pair) to produce a digital signature (e.g., digital signature 443). In this case, the digital asset 440 includes the digital asset public key 441 and optionally one or more of the digital asset data 442 and/or the digital asset signature 443. The server 18 may then create an owner key 411. In some embodiments the owner key 411 is a symmetric encryption key. The server 18 is then configured to encrypt the digital asset private key 410 using the owner key 411 to produce the encrypted digital asset private key 412 as shown in FIG. 4B. In some embodiments, the owner key 411 is transmitted to the first computing device. In this case the server 18 destroys/discards the digital asset private key 410 and the owner key 411 from the registry 41. The registry 41 then stores only the encrypted digital asset private key 412. Based on the registration process above, the owner 42 of the first computing device is the only one who can decrypt the encrypted digital asset private key 412 to produce the digital asset private key 410. Ownership is proven when the produced digital asset private key 410 and the digital asset public key 441 is the same digital asset key pair. Neither the asset issuer 410 nor the registry 41 has access to the digital asset private key 410 without the owner 42 (e.g., first computing device) providing owner key 411.

To verify or prove the digital asset private key 410 and the digital asset public key 441 are the same pair, the server 18 may enable a third party other than server 18 to transmit a random number to the registry 41 to be encrypted with at least one digital asset key from the digital asset key pair (e.g., the digital asset private key 412). The third party may then use at least one digital asset key of the digital asset key pair (e.g., digital asset public key 441) to decrypt the encrypted random number to get the random number. A digital signature can also be used to verify that the digital asset key pair are the same key pair.

In another example embodiment, the server 18 is further configured to receive, from the first computing device, owner identity data, and prior to transferring ownership of the digital asset to be associated with the second computing device, verify a user of the first computing device using the owner identity data. The owner identity data may include at least one key of an encryption key pair such as a public key of the key pair, a telephone number, an email address, a passport, a driver's license, or biometric data.

In some embodiments, the server is further configured to issue and transfer ownership of the digital asset by receiving, from an issuing computing device, a request to issue a digital asset and generating, in response to the request, an owner key pair and a facilitator key pair. In some embodiments, the owner key pair comprises an owner private key and an owner public key, and the facilitator key pair comprises a facilitator private key and a facilitator public key. The server 18 may then associate at least one key of the owner key pair and at least one key of the facilitator key pair (e.g., the owner public key and the facilitator public key) to the digital asset, and store a derived secret key corresponding to the secret key to be utilized for verifying the secret key is associated with the digital asset.

In another example embodiment, the server 18 may be further configured to receive, from a verifier computing device, a request to verify an owner device is associated with the owner of the digital asset. The server may then obtain the owner key from the owner via the owner's computing device. The server decrypts the encrypted digital asset private key with the owner key to produce the digital asset private key. The server may then create a digital signature using the digital asset private key as proof that the owner owns the digital asset. In some embodiments, the server destroys the digital asset private key and the owner key from the registry of the server. In some embodiments, the server may receive a request to transfer ownership of the digital asset to be associated with a second owner device. In this case, the server 18 may upon the verification that the owner device owns the digital asset, store a second derived secret data corresponding to a second secret data associated with the second owner device to be utilized for verifying the second secret data is associated with the second owner device.

d. Use Case Examples

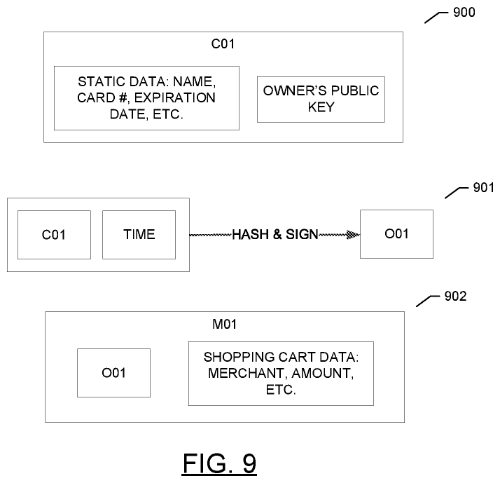

FIG. 9 provides an example use case related to an online purchasing process in which a credit card company issues a card comprising static information such as credit card owner name, credit card number, expiration date, and the like. In addition, the card information includes an owner's public key which is used to specify the ownership of the credit card. Said data is shown as block 900 of FIG. 9.

As shown by 901, the data set comprising the static information and the owner's public key (e.g., CO1) is issued to the owner of the credit card. When the owner is ready to share the card with a merchant to purchase product or services. Data set CO1 plus dynamic data such as timestamp is hashed and signed with the owner's private key as depicted in 901. A random one time access link 001 is generated and shared with the merchant. A counter from the owner's device may be used to count how many times the link has been accessed. For example, there can be a rule enforced that the access link will expire in 30 seconds, or after one time access, etc.

The merchant may then forward access link 001, and shopping cart information (such as merchant ID, amount, etc.) to the credit card company for authorization as shown by data set MO1 in 902. In some embodiments, MO1 may be digitally signed with the owner's private key. The credit card company using the access link 001 is able to verify the signature of data set CO1 by using the public key of the owner to make sure the credit card is indeed being used by a true owner of the credit card. In some embodiments, the access link 001 may expire within a predefined time (e.g., 30 seconds so that the link cannot be reused).

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus for transferring ownership of a digital asset, the apparatus comprising:
at least one processor; and
at least one non-transitory memory including computer program code instructions for one or more programs,
the at least one memory and the computer program code configured to, with the at least one processor, cause the apparatus to perform at least the following:
receive, from a first computing device, a digital asset identifier;
receive a request to transfer ownership of the digital asset to be associated with a second computing device;
derive a first owner key from the digital asset identifier;
derive a digital asset key from the first owner key;
generate, in response to the request, a second owner key; and
verify that the second computing device has ownership of the digital asset by verifying the digital asset key derived from the second owner key is related to at least one key of a digital asset key pair.

2. The apparatus of claim 1, wherein the at least one non-transitory memory stores computer program code instructions that, when executed by the at least one processor, further configure the apparatus to:
remove the first owner key and the digital asset key from a registry.

3. The apparatus of claim 1, wherein the digital asset identifier comprises i) a password associated with a user, a passcode associated with the user, an encryption key, or an identifier unique to the first computing device; and/or ii) data identifying the digital asset.

4. The apparatus of claim 1, wherein the at least one non-transitory memory stores computer program code instructions that, when executed by the at least one processor, further configure the apparatus to encrypt the digital asset key with the second owner key of the second computing device to produce an encrypted digital asset key.

5. The apparatus of claim 1, wherein the at least one non-transitory memory stores computer program code instructions that, when executed by the at least one processor, further configure the apparatus to:
receive, from the first computing device, owner identity data; and
prior to transferring ownership of the digital asset to be associated with the second computing device, verify a user of the first computing device using the owner identity data.

6. The apparatus of claim 5, wherein the owner identity data comprises at least one of: at least one key of an encryption key pair, a telephone number, an email address, a passport, a driver's license, or biometric data.

7. An apparatus for issuing and transferring ownership of a digital asset, the apparatus comprising:
at least one processor; and
at least one non-transitory memory including computer program code instructions for one or more programs,
the at least one memory and the computer program code configured to, with the at least one processor, cause the apparatus to perform at least the following:
receive a request to issue a digital asset;
associate at least one owner key of an owner key pair and at least one facilitator key of a facilitator key pair to the digital asset, wherein the at least one owner key and a corresponding owner key form the owner key pair, the corresponding owner key is associated with an owner device; and wherein the at least one facilitator key and a corresponding facilitator key form the facilitator key pair, the corresponding facilitator key associated with a facilitator device;
store a derived secret data corresponding to a secret data to be utilized for verifying the owner device; and
transfer ownership of the digital asset based at least in part on the corresponding owner key, the corresponding facilitator key and the secret data.

8. The apparatus of claim 7, wherein the at least one non-transitory memory stores computer program code instructions that, when executed by the at least one processor, further configure the apparatus to:
receive a request to verify the owner device owns the digital asset;
verify the owner device owns the digital asset using the derived secret data; and
upon verification that the owner device owns the digital asset, apply a digital signature using the corresponding facilitator key from the facilitator key pair.

9. The apparatus of claim 8, wherein the at least one non-transitory memory stores computer program code instructions that, when executed by the at least one processor, further configure the apparatus to:
verify that ownership of the digital asset is associated with the owner device based at least in part on respective digital signatures of both the facilitator device and the owner device.

10. The apparatus of claim 9, wherein the at least one non-transitory memory stores computer program code instructions that, when executed by the at least one processor, further configure the apparatus to:
receive a request to transfer ownership of the digital asset to be associated with a second owner device;
upon the verification that the owner device owns the digital asset, store a second derived secret data corresponding to a second secret data associated with the second owner device to be utilized for verifying the second secret data is associated with the second owner device.

11. A computer implemented method for transferring ownership of a digital asset, the computer implemented method comprising:
receiving, from a first computing device, a digital asset identifier;
receiving a request to transfer ownership of the digital asset to be associated with a second computing device;
deriving a first owner key from the digital asset identifier;
deriving a digital asset key from the first owner key;
generating, in response to the request, a second owner key; and
verifying that the second computing device has ownership of the digital asset by verifying the digital asset key derived from the second owner key is related to at least one key of a digital asset key pair.

12. The computer implemented method of claim 11, further comprising:
removing the first owner key and the digital asset key from a registry.

13. The computer implemented method of claim 11, wherein the digital asset identifier comprises i) a password associated with a user, a passcode associated with the user, an encryption key, or an identifier unique to the first computing device; and/or ii) data identifying the digital asset.

14. The computer implemented method of claim 11, further comprising:
encrypting the digital asset key with the second owner key of the second computing device to produce an encrypted digital asset key.

15. The computer implemented method of claim 11, further comprising:
receiving, from the first computing device, owner identity data; and
prior to transferring ownership of the digital asset to be associated with the second computing device, verifying a user of the first computing device using the owner identity data.

16. The computer implemented method of claim 15, wherein the owner identity data comprises at least one of: at least one key of an encryption key pair, a telephone number, an email address, a passport, a driver's license, or biometric data.
